(19) United States
(12) Patent Application Publication
(10) Pub. No.: US 2008/0022980 A1
(43) Pub. Date: Jan. 31, 2008

(54) RECIPROCATING INTERNAL COMBUSTION ENGINE AND A METHOD OF ELIMINATING PARTICLES FROM BURNT GAS FOR SUCH A RECIPROCATING ENGINE

(76) Inventor: Jean Frederic Melchior, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/833,616

(22) Filed: Aug. 3, 2007

Related U.S. Application Data
(63) Continuation of application No. PCT/FR06/00203, filed on Jan. 30, 2006.

(30) Foreign Application Priority Data
Feb. 4, 2005 (FR) 0501156

(51) Int. Cl. F02B 33/02; F01N 3/021

(52) U.S. Cl. 123/559.1; 123/585; 60/311; 60/598

(57) ABSTRACT

The invention relates to a reciprocating internal combustion engine having at least one cylinder (1a) provided with at least one admission valve (2) and at least one exhaust valve (3). The pulsating stream of first gas is exhausted from the cylinder (1a) via an exhaust duct (5) fitted with an expansion nozzle leading tangentially to a peripheral wall of a circularly symmetrical centrifuge chamber (10) and perpendicularly to the axis of said chamber. The centrifuge chamber (10) communicates with a duct for feeding the turbines of a turbocharger unit (30) via an annular radial diffuser.

### CROSS REFERENCE TO RELATED APPLICATIONS

This application is a Continuation Application of International Application No. PCT/FR2006/000203, filed Jan. 30, 2006, which claims priority from French patent Application No. 0501156 filed Feb. 4, 2005.

### FIELD AND BACKGROUND OF THE INVENTION

The present invention relates to a reciprocating internal combustion engine and to a method of eliminating particles from burnt gas for such a reciprocating internal combustion engine.

Reciprocating internal combustion engines operating on two-stroke or four-stroke cycles and fitted to motor vehicles are subjected to transient operating conditions frequently and at speed, and they are also subjected to severe limitations concerning the pollutants they can exhaust to the atmosphere. These pollutants are essentially nitrogen oxides NOX, carbon monoxide CO, unburned hydrocarbons HC, and particles.

At present, reciprocating internal combustion engines operating with a four-stroke cycle are in the most widespread use and they can be of the controlled ignition type or of the diesel type.

Controlled ignition type engines are generally not associated with a turbocharger unit and they do not emit particles. In contrast, they emit large amounts of nitrogen oxide, of carbon monoxide, and of unburned hydrocarbons, which are usually eliminated in a three-way catalytic converter that is well adapted to stoichiometric mixture combustion. However, the efficiency of engines of that type is degraded by heat losses due to the high temperature of the operating cycle and to the pumping work expended in throttling the air admission stream.

Diesel type engines are being associated more and more frequently with a turbocharger unit having a single turbocharger that suffices to produce an admission pressure of two to three bars absolute.

The turbine of the turbocharger is generally of variable geometry, thus enabling it to adapt to speed variations and to the varying back pressure from the exhaust system of the engine. Emissions of carbon monoxide and of unburned hydrocarbons are low, but they still need an oxidation catalyst in the exhaust system.

Furthermore, nitrogen oxide emissions require cooled burnt gas to be recycled, and particle emissions are presently limited by excess air which also generates nitrogen oxides.

However, the forthcoming standards to be applied to internal combustion engines, and in particular to diesel type engines, are making it necessary for manufacturers to integrate in the exhaust system a particle filter that is capable of being regenerated. Unfortunately, that disposition suffers from the major drawback of severely degrading turbocharging and the performance of the engine.

Diesel type engines thus run the risk of losing their qualities of efficiency and robustness that make them preferable to controlled ignition type engines, in spite of being more expensive.

The post-treatment devices used at present are situated downstream from the turbines of the turbocharger unit, and such devices generate back pressure that can be as great as 1 bar when the engine is at full power. Under such conditions, equality between the expansion ratio of the turbines and the compression ratio of the compressors in the turbocharger unit requires exhaust pressure to be twice the admission pressure to the engine. A fortiori, an expansion ratio greater than a compression ratio leads to pressure differences between admission and exhaust that are unacceptable for highly supercharged engines with a high burnt gas recycling ratio. Furthermore, the temperature downstream from the turbines is often too low to initiate catalysis in the treatment device.

For all those reasons, it is more logical to perform post-treatments upstream from the turbines where the temperature is more favorable for catalytic reactions and where the pressure reduces head losses. Furthermore, for engines that operate with a four-stroke cycle, the variations in such head losses have no effect on turbocharging and thus on the supply of air to the engine.

Post-treatment upstream from the turbines in the turbocharger unit have already been tried by manufacturers, but without success since the main difficulty is due to the volume of the device that dissipates the gas pressure pulses needed for driving the turbocharger unit when the engine is running at speeds slower than the adaptation speed (engine speed at which exhaust pressure equals admission pressure). French patent application No. 03/03728 likewise in the name of the Applicant, discloses a reciprocating engine with burnt gas recirculation in which turbocharging is adapted for an engine speed that is less than the minimum utilization speed.

Under such conditions, supercharging at constant pressure begins as soon as the engine reaches its minimum utilization speed, independently of the volume of the exhaust manifold.

Nevertheless, the poor isentropic efficiency of very small turbomachines suitable for motor vehicle engines, when associated with the low temperature of gas generated by cold cycles, means that the total pressure of the gas at the inlet of the turbines is greater than the total pressure of the air delivered by the compressors. This back pressure increases the pumping losses of engines operating with a four-stroke cycle and makes two-stroke engines unsuitable.

### SUMMARY OF THE INVENTION

One of the objects of the invention is to produce high supercharging in engines with a high ratio of burnt gas recycling and at low exhaust temperature by limiting the exhaust back pressure that is detrimental to the efficiency of the engine.

Another object of the invention is to eliminate the pollutants generated by cold cycles, essentially carbon monoxide, unburned hydrocarbons, and particles generated by direct injection of a liquid fuel.

The invention thus provides a reciprocating internal combustion engine comprising firstly at least one cylinder provided with at least one admission valve and at least one exhaust valve through which a pulsating stream of burnt gas is exhausted having a driving pressure equal to the pressure Pd that exists in the cylinder when said at least one exhaust valve is opened, and secondly a turbocharger unit actuated by said burnt gas and serving to feed said at least one cylinder with cooled compressed air, the engine being characterized in that at least a fraction of the pulsating burnt gas stream is taken from said at least one cylinder via an exhaust duct having an expansion nozzle delivering tangentially to the peripheral wall of a circularly symmetrical centrifuge chamber and perpendicularly to the axis of said chamber, and the centrifuge chamber communicates with a feed duct for feeding the turbines of the turbocharger unit via an annular radial diffuser coaxial about the axis of said chamber and having an inlet diameter D, the static pressure in the centrifuge chamber being maintained at a pressure Ps less than the pressure Pd so as to accelerate a fraction of the burnt gas feeding a burnt gas ring into rapid rotary movement about the axis of the centrifuge chamber and that is exhausted towards the turbines, by becoming compressed and slowing down in the radial diffuser.

According to other characteristics of the invention:
the centrifuge chamber has an axial orifice of diameter d smaller than the inlet diameter D of the radial diffuser communicating with a recycling duct for recycling the burnt gas, and the volume of a space lying between a notional cylinder of diameter D and a coaxial cylinder of diameter d both of length equal to the distance between the axial orifice and the inlet of the radial diffuser is preferably greater than two unit cylinder capacities of the engine;
the centrifuge chamber presents a volume greater than at least three times the unit cylinder capacity of the engine in order to stabilize static pressure therein when the axial orifice is closed;
the centrifuge chamber communicates via the axial orifice with a volume that is not less than three times the unit cylinder capacity of the engine in order to stabilize the static pressure therein;
the centrifuge chamber communicates with the recycling duct via the axial orifice, the static pressure at said orifice being substantially equal to the admission pressure of the engine;
the axial orifice feeds an annular radial diffuser having an inlet diameter d, the static pressure at said axial orifice being less than the admission pressure of the engine;
said at least one nozzle leads into said centrifuge chamber in a substantially conical segment extending between a zone of greatest diameter of said chamber and said axial orifice of diameter d;
the second exhaust valve is connected via an exhaust duct to the recycling duct downstream from the corresponding axial orifice, the exhaust valve of the second duct opening after the exhaust valve of the first duct has opened, once the pressure in the corresponding cylinder has dropped sufficiently;
the engine includes, between the annular radial diffuser of the duct for feeding the turbines of the turbocharger unit and said turbines, an axial flow particle filter, that is preferably cylindrical and associated with means for eliminating particles deposited on the particle filter;
the means for eliminating particles comprise a collector pressed against the inlet face of the particle filter and movable over said face to sweep the entire surface area of said face periodically, said collector communicating with a zone in which the static pressure is less than the pressure downstream from the particle filter so as set up a counter-current flow of gas through the sector of said filter that is covered by the collector;
the collector communicates with the recycling duct to burn the particles extracted from said particle filter in said at least one cylinder;
the collector communicates with an axial zone of the centrifuge chamber in the vicinity of the radial diffuser of the turbine feed duct via a particle combustion zone situated in said chamber; and
the particle filter is in the form of a circular cylinder having two plane end faces, said collector being driven to rotate about the axis of the filter.

The invention also provides a method of eliminating particles from the burnt gas from a reciprocating internal combustion engine as mentioned above, the method being characterized by the following steps:
passing the exhausted burnt gas through an axial flow particle filter; and
periodically putting each sector of the inlet face of the particle filter into communication with a zone where the static pressure is lower than the pressure downstream from the particle filter so as to establish a counter-current flow of gas through each sector of said particle filter, thereby entraining the particles taken from said filter towards a zone where said particles are burnt.

According to other characteristics of the method:
the zone where the static pressure is lower than the pressure downstream from the particle filter is formed by a burnt gas recycling circuit provided with a valve for adjusting the recycled gas flow rate, the particles taken being burnt in said at least one cylinder of the engine;
the zone where the static pressure is less than the pressure downstream from the particle filter is formed by an axial zone of the centrifuge chamber;
the axial zone communicates with the recycling circuit, the particles taken being burnt in said at least one cylinder of the engine; and
the axial zone communicates with the turbocharger unit, the particles taken being burnt in the centrifuge chamber.

### BRIEF DESCRIPTION OF THE DRAWINGS

Other characteristics and advantages of the invention appear from the following description made with reference to the accompanying drawings, in which:

FIG. 1 is a diagram of a burnt gas exhaust and oxidizer feeder assembly for a reciprocating internal combustion engine in accordance with the invention;

FIG. 2 is a diagrammatic view on a larger scale and in axial section of a chamber for centrifuging the pulsating stream of burnt gas delivered by the engine;

FIG. 3 is a section view on line 3-3 of FIG. 2;

FIGS. 4 and 5 are diagrammatic axial section views of two variants of the centrifuge chamber;

FIGS. 6 and 7 are diagrammatic views respectively in axial section and in section on line 7-7 of the centrifuge chamber associated with means for eliminating burnt gas particles;

FIGS. 8 to 9 are diagrammatic axial section views of two variants of means for eliminating burnt gas particles; and

FIGS. 10 to 12 are diagrams showing various examples of burnt gas exhaust and oxidizer feed circuits for a four-cylinder reciprocating internal combustion engine.

### MORE DETAILED DESCRIPTION

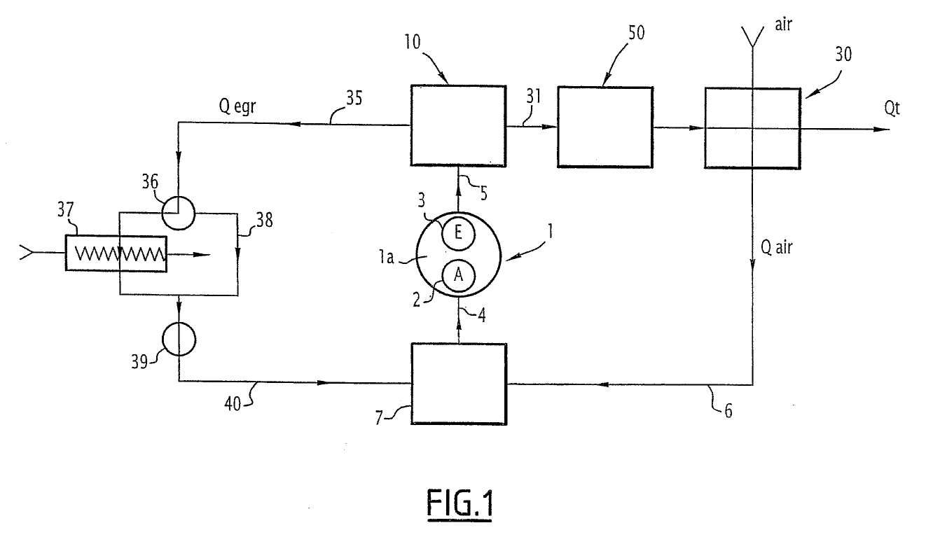

FIG. 1 is a diagram of an engine 1 having at least one cylinder 1a provided with at least one admission valve 2 and at least one exhaust valve 3. In the embodiment shown in this figure, the cylinder 1a has one admission valve 2 and one exhaust valve 3.

The engine 1 is associated with an assembly of means described below that enable a mixture of pure air and burnt gas to be delivered to the engine 1 at a pressure, a temperature, and a recycled gas content that are adjustable at all times as a function of the operating parameters of the moment.

The admission valve 2 is connected to an admission manifold 4 and the exhaust valve 3 is connected to an exhaust duct 5 that leads to a centrifuge chamber given overall reference 10. The centrifuge chamber 10 transforms the pulsating stream of burnt gas delivered by the cylinder 1 of the engine 2 into two streams, respectively a stream referenced Qt and a stream referenced Qegr, at pressures that are substantially constant.

The stream Qt is directed to a turbocharger unit given overall reference 30. The turbocharger unit 30 expands the stream Qt for rejection to the atmosphere and it takes in atmospheric air referenced Qair for feeding to the cylinder 1a of the engine 1 via a duct 6, a mixer 7, and an admission manifold 4. The turbocharger unit 30 is connected to the centrifuge chamber 10 by a duct 31.

The cool air stream Qair is advantageously compressed, in conventional manner, in the turbocharger unit 30, e.g. initially by a low pressure turbocharger, and is then cooled prior to being compressed a second time by a high pressure turbocharger and cooled a second time. The stream Qt which corresponds to 50% to 70% of the burnt gas stream, equal to the cool air stream Qair plus the stream of burnt fuel, is expanded successively in the high pressure turbine and in the low pressure turbine before being exhausted to the atmosphere. Alternatively, the stream Qt may feed the high pressure turbine and the low pressure turbine of the turbocharger unit 30 in parallel.

The stream Qegr at the outlet from the centrifuge chamber 10 is directed to a recycling circuit that comprises a duct 35 connecting said centrifuge chamber 10 to a distributor valve 36 enabling the stream Qegr to be directed either towards a cooler 37 or else to a bypass duct 38. Downstream from the assembly constituted by the distributor valve 36, the cooler 37 and the bypass duct 38, the recycling circuit includes a valve 39 for adjusting the stream Qegr connected to the mixer 7 by a duct 40. The mixer 7 receives the streams Qair of Qegr to feed the cylinder 1a of the engine 1 with a uniform oxidizer mixture. Thus, the stream Qegr which represents 30% to 50% of the burnt gas stream is cooled under pressure in adjustable manner in the cooler 37, and is then mixed intimately with the cool air stream Qair in the mixer 7 in order to feed the admission manifold 4. The temperature of the low Qegr can advantageously be adjusted by the distributor valve 36 short-circuiting all or some of the stream conveyed through the cooler 37.

The duct 31 connecting the centrifuge chamber 10 to the turbocharger unit may be fitted with a post-treatment system given overall reference 50 and described below.

The limit of about 1600 K for the maximum temperature of the operating cycle of the engine 1 leads to a proportional limit on the temperature at the end of expansion in the cylinder 1a that is available for turbocharging. Since this temperature is fixed, the power from the turbines of the turbocharger unit 30 depends on the total pressure of the stream Qt. It can thus be seen that it is advantageous to make optimum use of the driving pressure Pd available in the burnt gas for expansion in the cylinder 1a.

According to the invention, the distribution and the flows of the gas streams in the centrifuge chamber 10 are organized in original manner for optimizing the use of said pressure in the above-mentioned context.

There follows a summary of some of the basic physics of how a reciprocating internal combustion engine operates.

To a first approximation, mass conservation during a closed-stage drive cycle requires the following relationship to be satisfied between the conditions in the cylinder at the beginning of compression and at the end of expansion:
Pd/Pc=Vc/Vd×Td/Tc
where Pd, Vd, Td, and Pc, Vc, Tc are respectively the pressure, the volume, and the temperature of the gas at the end of expansion and at the beginning of compression.

For an engine in which the valves are fitted with variable-timing means, Pd/Vc can be adjusted by acting on Vc/Vd at constant admission temperature. With fixed-timing valves, Pd/Pc can be adjusted by acting on admission temperature. A fortiori, Pd/Pc can be adjusted by acting on both parameters in order to adjust another variable of the cycle, e.g. the compression temperature Pc which governs ignition. For a given admission pressure, the driving pressure of the burnt gas can thus be adjusted by parameters internal to the engine (valve timings) or by external parameters (admission temperature).

In order to facilitate understanding the description below, a conventional engine is selected by way of example in which exhaust opening and admission closure are situated close to the bottom dead-center point of the piston in the cylinder 1a. Under such conditions:
Vd=Vc and Pd/Pc=Td/Tc

For an admission temperature of 325 K and an exhaust temperature of 750 K, Pd=2Pc.

In this embodiment, half of the burnt gas present in the cylinder 1a can be expanded from a driving pressure greater than Pc, a driving pressure for which the weight average is situated at 1.5 Pc.

For a stream Qegr representing 50% of the exhaust stream, half of the hot gas is for cooling and transferring into the admission manifold 4 where the pressure is close to Pc. The other half is for being expanded in the turbines of the turbocharger unit 30 down to atmospheric pressure.

The centrifuge chamber 10 is designed to direct the higher energy burnt gas towards the turbines of the turbocharging unit 30 and the lower energy gas towards the recycling duct 35. The transfer of the recycled flow Qegr from the centrifuge chamber 10 to the admission manifold 4 can take place at a pressure close to Pc, providing the recycling duct is large enough.

The delivery work from the recycled gas of the cylinder 1a is developed by the piston of said cylinder in a four-stroke engine, or by the fresh charge in a two-stroke engine.

In contrast, the energy available in the burnt gas stream Qt is needed to perform the following operations:
to deliver in the turbines of the turbocharging unit 30 the work absorbed by the compressors in order to reach the required admission pressure Pad;
to generate the extra pressure needed for passing through the post-treatment system 50; and
to create an admission pressure greater than the static pressure downstream from the cylinder 1a during the sweeping stage for a two-stroke engine.

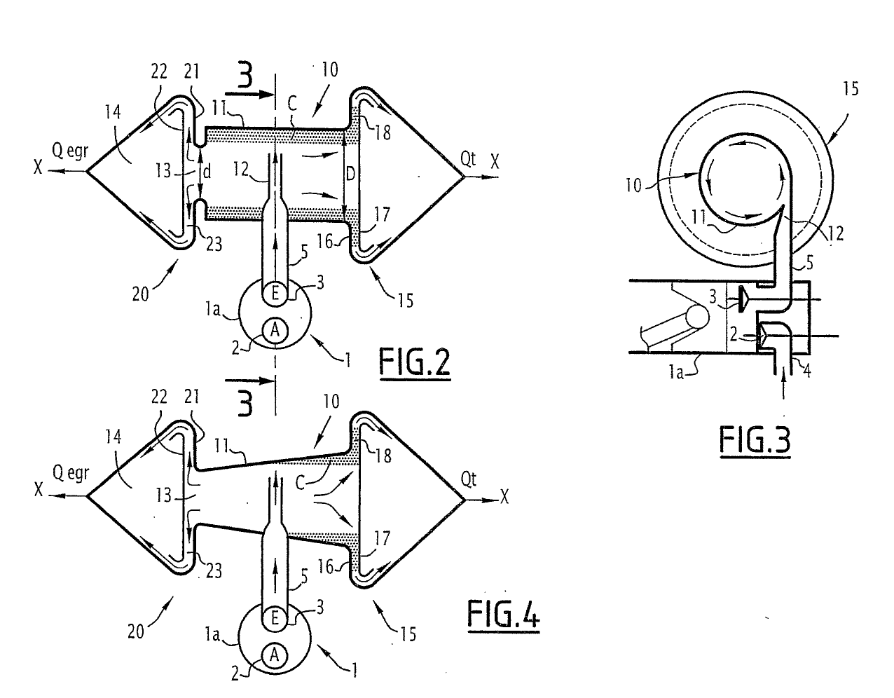

With reference now to FIGS. 2 and 3, there follows a description of a first embodiment of the centrifuge chamber 10.

As can be seen in the figures, the centrifuge chamber 10 is generally circularly symmetrical about an axis XX. In the embodiment shown in these figures, the peripheral wall 11 of this circularly symmetrical chamber is cylindrical in shape.

The exhaust duct 5 putting the chamber of the cylinder 1a into communication with the centrifuge chamber 10 when the exhaust valve 3 opens is provided at its free end with an expansion nozzle 12 delivering tangentially to the wall 11 in said centrifuge chamber 10 and perpendicularly to the axis XX of said centrifuge chamber.

Thus, the pulsating stream of burnt gas exhausted from the cylinder 1a at a driving pressure Pd equal to the pressure that exists in the cylinder when the exhaust valve 3 is opened, is expanded by the nozzle 12 that delivers tangentially to the peripheral wall 11 of the centrifuge chamber 10 in which static pressure is maintained substantially constant. The potential energy of the gas is thus transformed in part into kinetic energy and stored in the rotating mass of gas inside the centrifuge chamber 10. The speed of the gas delivered by the nozzle 12 decreases with the driving pressure of the flow decreasing from the pressure Pd to the static pressure that exists in the centrifuge chamber 10 at the outlet from the nozzle 12.

At the beginning of expansion, this speed can approach the speed of sound, and it decreases down to zero when the pressures equalize.

The axially symmetrical field of static pressures inside the centrifuge chamber 10 is governed by the centrifuging effect, which itself depends on how tangential speeds vary along a radius of said chamber 10. The faster burnt gas is thus naturally located towards the periphery of the centrifuge chamber 10, whereas the slower burnt gas becomes concentrated around the axis XX of the chamber 10. The static pressure and the total pressure decrease simultaneously between the periphery of the centrifuge chamber 10 and its axis XX where the static pressure can drop well below the pressure at the beginning of compression Pc. The total pressure of the fast gas is equal to the static pressure plus the dynamic pressure, whereas the pressure at the outlet from the nozzle 12 is the static pressure minus the dynamic pressure.

The centrifuge chamber 10 is dimensioned to limit kinetic energy losses due to friction between the ring of gas and the walls of the chamber. The length of time the fast gas is present in the centrifuge chamber 10 must therefore be minimized.

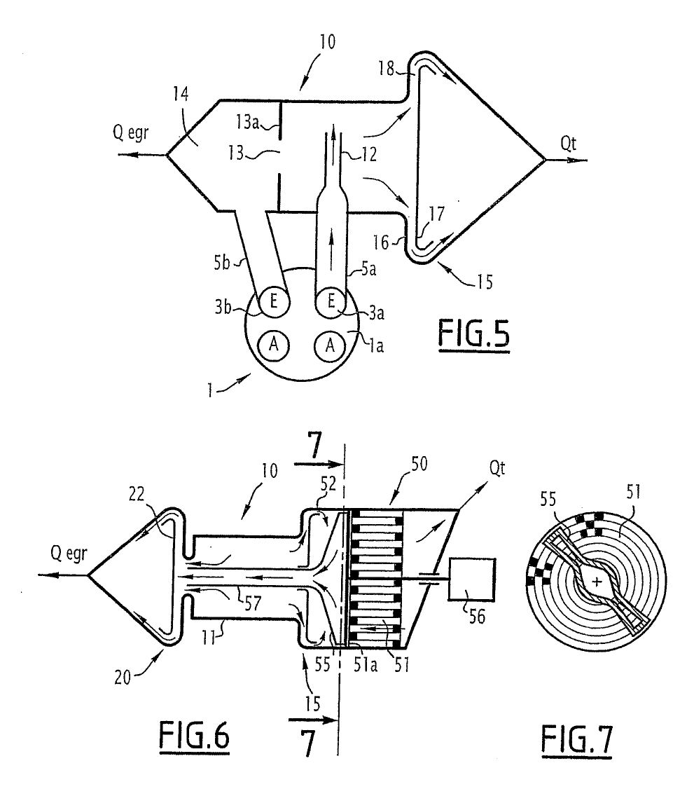

As shown in FIG. 2, in order to stabilize the static pressures inside the centrifuge chamber 10, the centrifuge chamber 10 is sufficiently large, or as shown in FIG. 5 it communicates via at least one axial orifice 13 of diameter d less than the greatest diameter of the centrifuge chamber 10 with a volume 14 communicating with the recycling duct 35 and presenting a volume that is large compared with the amplitude of the pulses. The orifice 13 has the breathing of the chamber 10 pass therethrough when the ring C formed by the fast burnt gas expands and contracts at the rate at which the exhaust valve 3 opens and closes.

Thus, the fast gas Qt is concentrated in the toroidal zone of the centrifuge chamber 10 in the form of the ring C where the diameter of the chamber 10 is greater than the diameter d of the orifice 13. The volume of this toroidal zone must be greater than the amplitude of the volume pulses in the fast gas Qt, and this amplitude lies in the range one to two unit cylinder capacities for a four-stroke, four-cylinder engine.

The centrifuge chamber 10 communicates with the duct 31 feeding the turbines of the turbocharger unit 30 via an annular radial diffuser 15 coaxial with said chamber 10 and having a minimum inlet diameter D. In the embodiment shown in FIG. 2, the inlet diameter D of the radial diffuser 15 is equal to the greatest diameter of the centrifuge chamber 10. In this example, the centrifuge chamber 10 has a diameter D over its entire length. The radial diffuser 15 thus outwardly extends the toroidal zone in which the fast gas Qt collects in the centrifuge chamber 10 so as to collect and slow down the fast gas.

The diffuser 15 is advantageously formed by two parallel walls 16 and 17 extending perpendicularly to the axis XX of the centrifuge chamber 10 and defining between them a space 18 through which the fast gas Qt passes. The flow rate of the fast gas Qt passing through the diffuser 15 is controlled by the turbines of the turbocharger unit 30. The flow rate of the gas stream Qt is a function of the width of the space 18, i.e. the distance between the walls 16 and 17 of the radial diffuser 15, and of the section of the turbines in the turbocharger unit 30.

The static pressure in the centrifuge chamber 10 is maintained at a value Ps less than the pressure Pd in order to accelerate a fraction of the burnt gas feeding the burnt gas ring C that is rotating rapidly around the axis XX of the centrifuge chamber 10, and that is exhausted towards the turbines of the turbocharger unit 30 by being compressed and slowed down in the radial diffuser 15.

To stabilize the static pressure in the centrifuge chamber 10, two solutions can be envisaged. In the first solution, the centrifuge chamber 10 presents a volume that is not less than three unit cylinder capacities. Under such circumstances, the recycled gas Qegr can be recompressed in a radial diffuser 20, as described below.

In the second solution, the centrifuge chamber 10 presents a smaller volume in order to limit the area wetted by the rapidly rotating ring of gas, and it communicates via the orifice 13 with a volume 14 of not less than three unit cylinder capacities.

In another variant, the inlet to the radial diffuser 15 may have a diameter D that is less than the maximum diameter of the centrifuge chamber 10.

In general, in order to maintain all of the fast gas in the chamber 10 during breathing variations in the volume of the ring of gas in rotation, dimensions are selected so that the volume of a space between a cylinder having a diameter D and a coaxial cylinder having a diameter d, both cylinders being of the same length equal to the distance between the orifice 13 of diameter d and the inlet of diameter D of the radial diffuser 15, is preferably greater than two unit cylinder capacities of the engine.

After the end of each rapid expansion, the burnt gas still present in the cylinder 1a of the engine is delivered at low speed by the piston by a four-stroke engine or by the fresh charge with a two-stroke engine. The slow gas must reach the axial zone of the centrifuge chamber 10 while mixing as little as possible with the fast gas.

As shown in FIG. 2, the slow gas Qegr is mixed in part with the fast gas prior to being slowed down by an annular radial diffuser 20 putting the centrifuge chamber 10 into communication with the recycling duct 35. This radial diffuser 10 has a minimum diameter that is substantially equal to the diameter d of the outlet orifice 13. The radial diffuser 20 is made up of two parallel walls respectively referenced 21 and 22, extending perpendicularly to the axis XX of the centrifuge chamber 10 and defining between them a space 23 through the slow gas Qegr passes.

The total pressure at the inlet to this diffuser 20 is substantially at the same level as the admission pressure Qad of the engine 1, and the static pressure in said chamber 10 may be situated below said admission pressure Pad. The radial diffuser 20 raises the pressure of the slow gas stream Qegr to the level of the admission pressure in the admission manifold 4 of the engine 1. The radial diffuser 20 is optional with a four-stroke engine where the slow gas stream Qegr is pumped by the engine. However, it is necessary to create a slow gas stream Qegr in a two-stroke engine.

Each of the diffusers 15 and 20 is preferably smooth with the diameter ratio D/d of the two diffusers determining the potential of the slow gas stream Qegr.

The gas flow Qegr for recycling in the cylinder 1a is preferably slowed down by the radial diffuser 20, as shown in FIG. 2, prior to being fed either to the heat exchanger 37 cooled by the hot water for cooling the engine 1 and possibly followed by a second heat exchanger cooled by a water circuit at low temperature (not shown), or else to the bypass duct 38. The control valve 36 serves to vary the fraction of the gas stream Qegr that is cooled, and the recycle valve 39 situated upstream or downstream from the heat exchanger 37 serves to control said flow rate Qegr. The burnt gas as cooled in this way, the burnt gas passing via the bypass duct 38, and the fresh air Qair are all mixed together intimately in the mixer 7 prior to penetrating into to the admission manifold 4 and the cylinder 1a via the admission valve 2.

With an engine operating under transient conditions, controlling the flow rate of the recycled gas Qegr is highly effective for increasing the quantity of oxygen available for combustion in the engine. The flow rate of the gas Qt passing through the turbines of the turbocharger unit 30 is increased to the detriment of the flow rate of recycled gas Qegr which is then replaced instantaneously by fresh air. This operation moves the operating points in the characteristic diagrams of the compressors and takes place without waiting for the turbines in the turbocharger unit to accelerate. Under steady conditions, this method, which consists in increasing the pumping work performed by the piston, is used for fine adjustment only. In general, it is preferred to control the flow rate of the recycled gas Qegr by modifying the timings of the valves or by actuating the valve 36 for controlling the temperature of Qegr. With a reciprocating engine having only one exhaust valve 3 per cylinder, the slow gas travels along the same exhaust duct 5 as the fast gas, said duct opening out into the centrifuge chamber 10 via the expansion nozzle 12. These two streams, i.e. the fast gas stream and the slow gas stream, are thus separated in the centrifuge chamber 10.

In order to limit mixing between these two streams, the nozzle 12, as shown in FIG. 4, opens out into a conical zone of the centrifuge chamber 10 interconnecting a large diameter zone and a small diameter zone. In the embodiment shown in FIG. 4, the outside wall 11 of the centrifuge chamber 10 forms a cone over the entire length of the centrifuge chamber 10, with the wall tapering towards the outlet orifice 13 of diameter d.

Given this taper, the gas coming from the expansion nozzle 12 heads in alternation towards the smaller diameter zone or towards the larger diameter zone depending on its ejection speed.

With only one exhaust valve 3 per cylinder, the section of the nozzle 12 must be small enough to accelerate the fast gas and large enough to avoid slowing down the slow gas.

Various shapes for the outer wall 11 of the centrifuge chamber 10 can be envisaged. The dimensioning of the exhaust duct 5 can be selected as a function of the desired objectives. The mass of gas that is stationary in the duct 5 when the exhaust valve 3 is closed, is propelled towards the centrifuge chamber 10 by the expansion of the gas in the following cycle, which thus loses momentum. In addition, the column of gas accelerated in this way in the duct 5 entrains behind it by inertia a fraction of low energy gas still present in the cylinder 1a. These two exchanges of momentum degrade the energy distinction between the gas stream Qt and the gas stream Qegr.

In order to optimize the power of the turbines in the turbocharger unit 30, the volume of the duct 5 must therefore be minimized. In order to sweep a two-stroke engine by the inertial effect, the volume of the duct 5 is preferably close to the unit cylinder capacity of the engine.

With a reciprocating engine having two exhaust valves 3a and 3b per cylinder 1a, one of the valves, e.g. the valve 3a, is used for fast gas, and the other one of the valves, e.g. the valve 3b, is used for slow gas, as shown in FIG. 5.

The fast gas travels along a duct 5a fitted with an expansion nozzle 12 and leading to the periphery of the centrifuge chamber 10, like the exhaust duct 5 described above, while the slow gas travels along a second exhaust duct 5b that opens out downstream from the outlet orifice 13. In this embodiment, the inside volume of the centrifuge chamber 10 is subdivided into two volumes situated on either side of the transverse partition 13a having the outlet orifice 13 formed therethrough, to provide a first volume into which the fast gas is directed coming from the exhaust valve 3a and a second volume into which the slow gas is directed coming from the exhaust valve 3b. The outlet orifice 13 then sees an alternating stream pass therethrough.

In this embodiment, the nozzle 12 fed solely with fast gas may have a section that is smaller than the section of the above-described embodiment.

The valve 3a of the exhaust duct 5a opens first, and once the pressure in the cylinder 1a has dropped sufficiently, the exhaust valve 3b of the duct 5b opens in turn in order to empty the cylinder 1a. The two valves 3a and 3b may close simultaneously at the end of the transfer cycle, with the separation of the gas into two streams then taking place within the cylinder 1a of the engine.

In a reciprocating engine operating with a four-stroke cycle, the quantity of burnt gas delivered by the engine is proportional to its speed of operation. The gas stream Qt is proportional to the section provided for the gas on being exhausted to the atmosphere, specifically the section of an orifice equivalent to the turbines in the turbocharger unit 30, and also to the pressure at which the turbines are fed, itself a function of the efficiency of the radial diffuser 15.

In order to guarantee nitrogen oxide depollution from a minimum speed of use of the engine, it is therefore necessary for the minimum section of the turbines to allow only about 60% of the gas stream emitted by the engine to pass when the engine is operating at its minimum utilization speed. When the engine accelerates, the ratio between the gas flow rate Qt and the gas flow rate Qegr can be adjusted by setting the valves of the engine, by the section of the turbines in the turbocharger unit, by the recycling valve 39, or by the valve 36 that adjusts the temperature of the stream Qegr, as mentioned in patent application No. 03/03728, likewise in the name of the Applicant.

In a variant, the ratio Qt/Qegr can also be adjusted by modifying the width of the space 18 provided between the walls 16 and 17 of the radial diffuser 15, or by the width of the space 23 provided between the walls 21 and 22 of the radial diffuser 20.

In another variant, the wall 22 of the radial diffuser 2 can be made to be movable by means of any appropriate type to move along the axis XX of the centrifuge chamber 10 in order to close the orifice 13. Under such circumstances, the movable wall 22 replaces the recycling valve 39.

The work developed by the turbines in the turbocharger unit 30 thus increases with increasing temperature and total pressure of the gas feeding them. For a given temperature, the adjustment of the turbine power is thus performed essentially by acting on the total pressure of the gas stream Qt by using actuators internal to the engine (timings of the valves and of the injection) and/or actuators that are external thereto (valve 39 and/or valve 36 of the circuit for the gas stream Qegr).

The total pressure of the gas stream Qt is approximately the sum of the static pressure that exists in the centrifuge chamber 10 plus the dynamic pressure associated with the speed of rotation of the gas. The ratio between these two components can be selected by adjusting the level of the static pressures in the centrifuge chamber 10. In a four-stroke engine, this adjustment can be performed by means of a valve in the duct for recycling the gas stream Qegr. When the recycling valve 39 is closed, the dynamic pressure starts from a maximum value and becomes zero when the amount of expansion in the nozzle 12 is equal to unity.

The annular radial diffuser 15 adapts automatically to intermediate aerodynamic conditions. At a high dynamic pressure, the gas flow Qt penetrates tangentially into the annular space 18 where it is subjected to diffusion. For zero dynamic pressure, the gas flow Qt passes radially through the diffuser 15 without loss of head.

In a variant shown in FIGS. 6 to 9, the reciprocating internal combustion engine is fitted with post-treatment devices 50 for post-treating the gas stream Qt and that are situated between the annular radial diffuser 15 and the inlet to the turbines of the turbocharger unit 30.

These post-treatment devices are formed by a catalytic particle filter 51 in which flow is axial and preferably cylindrical. The filter 51 has the gas stream Qt from the outlet of the radial diffuser 15 pass therethrough at a temperature that is always greater than 400° C., which temperature is sufficient to achieve catalytic oxidation of unburned hydrocarbons and of carbon monoxide, but not sufficient to burn the deposited particles that oxidize quickly only above 600° C.

In order to eliminate the particles deposited on the filter medium of the particle filter 51, a first method consists in allowing a certain weight of particles to accumulate at the inlet of the filter 51 and then in burning these particles in situ by causing the temperature of the gas passing through the particle filter to rise periodically, e.g. by discharging to the atmosphere a fraction of the air delivered by the high pressure compressor. Regeneration of the particle filter 51 takes place more quickly when it is performed frequently.

In a second method, the heavy particles centrifuged by the radial diffuser 15 are concentrated on a cylindrical surface 52 provided at the outlet from the radial diffuser 15 and upstream from the particle filter 51 in the flow direction of the gas stream Qt.

In a third method, a small fraction of the gas stream passing through the particle filter 51 is passed back through said filter 51 as a counter-current so as to entrain the particles towards a zone where they are burnt. For this purpose, and as shown in FIGS. 6 to 9, the particle filter 51 is associated with particle eliminator means comprising a collector 55 applied against the inlet surface 51a of the particle filter 51. The collector 55 is movable over said face so as to sweep the entire surface of the face 51a of the particle filter 51 periodically.

The collector 55 also communicates with a zone where the static pressure is less than the pressure downstream from the particle filter 51 so as to establish a counter-current gas flow through the sector of the filter 51 that is covered by the collector 55. The collector 55 is rotated by suitable means 56, e.g. an electric motor 56, at a speed that is adjusted to provide a complete cleaning cycle of the particle filter 51 periodically, e.g. once every second.

As shown in FIG. 6, the collector 55 is connected via a duct 57 situated on the axis XX of the centrifuge chamber 10 and leading to the level of the outlet orifice 13 where the static pressure is lower than the pressure downstream from the particle filter 51.

Thus, a small fraction of the filtered flow passes back through the small sector of the particle filter 51 that is covered by the collector 55 as a counter-current so as to entrain the particles that have become deposited therein towards the end of the duct 57.

The particles as collected in this way can be reinserted into the cylinder 1a with the recycled gas in order to be burnt therein. The sweeping stream implemented in this way thus contributes to the flow in the gas stream Qegr.

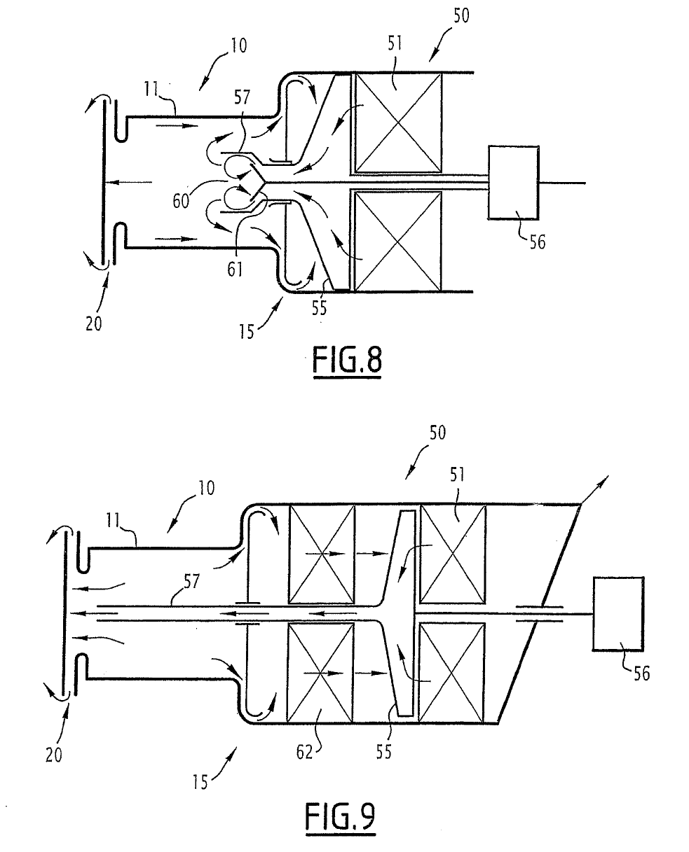

If the stream of gas that has just passed back through the particle filter 51 is sufficiently enriched in particles, it is possible to create a particle combustion zone 60 in an axial zone of the centrifuge chamber 10, as shown in FIG. 8. The particle-free gas stream is then exhausted towards the turbines of the turbocharger unit 30 by passing through the particle filter 51, and it then contributes to the flow in the gas stream Qt. The flow rate of this particle-free gas stream can be adjusted by a flame-catcher 61, e.g. constituted by a cone in order to maintain sufficient richness in the combustion zone 60.

In a variant shown in FIG. 9, an oxidation catalyst 62 separate from the particle filter 51 can be placed between the radial diffuser 15 and said particle filter 51. Under such circumstances, the sticky soluble particles are burnt in the oxidation catalyst 62 prior to penetrating into the particle filter 51 that stops only dry particles, which can easily be entrained by the gas stream recycled by the collector 55.

The above-mentioned methods of eliminating particles can be used separately or in combination.

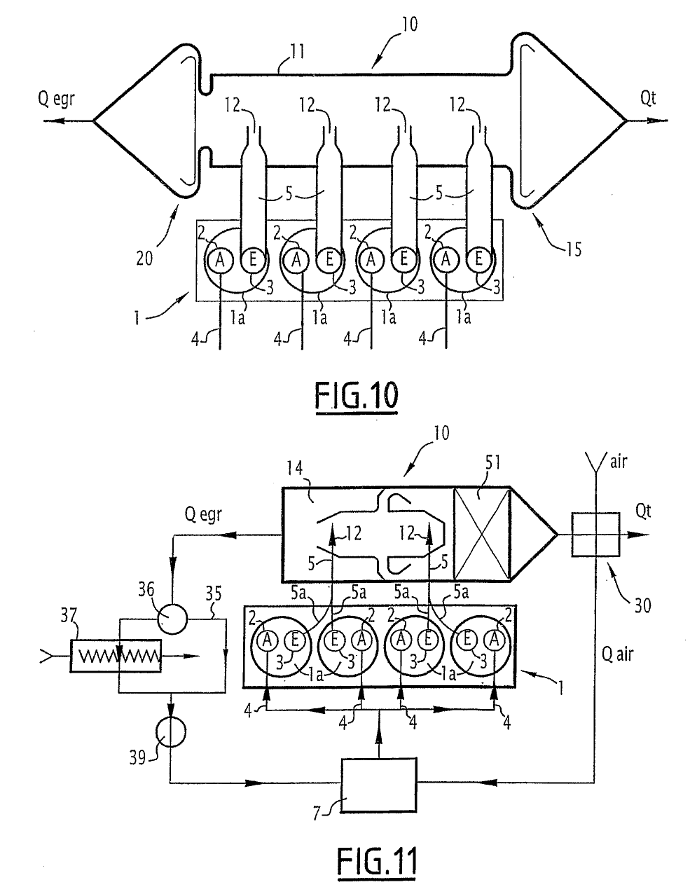

FIGS. 10 to 12 show various examples of configurations for the burnt gas exhaust circuit and the oxidizer feed circuit of a reciprocating four-cylinder internal combustion engine.

Other configurations could naturally be envisaged.

In these figures, elements that are common with the above-described embodiments are designated by the same references.

In the example of FIG. 10, the engine 1 has four cylinders 1a, each provided with one admission valve 2 and one exhaust valve 3. The exhaust valve 3 of each cylinder 1a is connected to an exhaust duct 5 that leads into the centrifuge chamber 10 in a manner that is identical to the above-described embodiment, i.e. via an expansion nozzle.

In the example of FIG. 11, the engine has four cylinders 1a, each provided with one admission valve 2 and one exhaust valve 3. In this configuration, the exhaust valves 3 from two adjacent cylinders 1a are disposed side by side and are connected via respective link ducts 5a to the exhaust duct 5 that leads into the centrifuge chamber 10. Each exhaust duct 5 is fitted with a nozzle disposed in the centrifuge chamber 10 in a manner identical to that of the above-described embodiment.

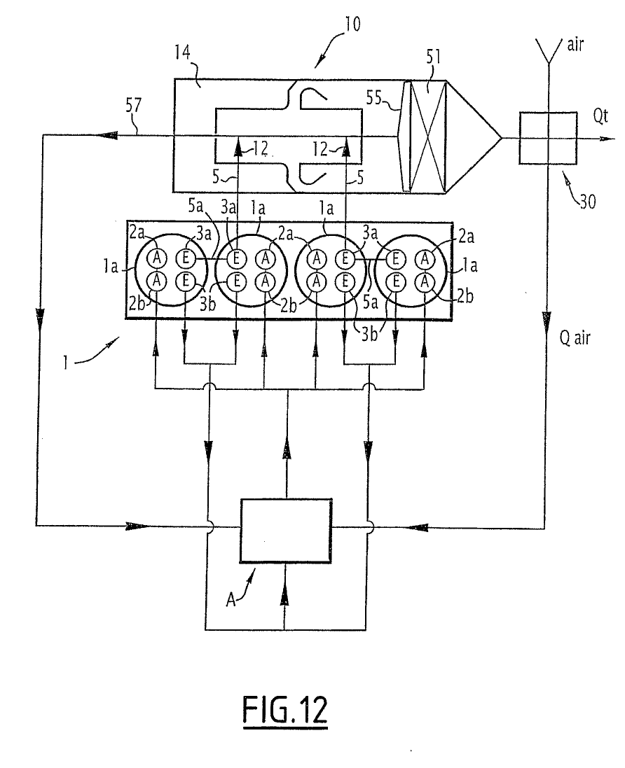

In the example of FIG. 12, the engine 4 has four cylinders 1a, each fitted with two admission valves, respectively 2a and 2b, and with two exhaust valves respectively 3a and 3b. Under such circumstances, the exhaust valves 3a and 3b of two adjacent cylinders 1a are disposed side by side.

The exhaust valve 3a of each cylinder 1a handles fast gas while the exhaust valve 3b handles slow gas.

In this embodiment, the exhaust valve 3a of the cylinder 1a is connected by a respective link duct 5a to the exhaust valve 3a of the adjacent cylinder 1a, and said exhaust valve 3a is connected to the exhaust duct 5 fitted with a small section nozzle that leads into the centrifuge chamber 10 in individual manner to the above-described embodiment.

The exhaust valves 3b are interconnected by a recycle duct 35 of large dimensions leading to an assembly referenced A that combines the elements of the circuit for cycling the gas Qegr together with the mixer 7. In this embodiment, the flow of gas recovered by the collector 55 is channeled directly by the duct 51 towards the assembly A in order to be sucked back into the engine 1. The valves 3a open first so as to cause the pressure in the cylinders to drop. The valves 3b open subsequently so as to deliver the slow gas.

The invention is particularly advantageous for a thermodynamic cycle having a high burnt gas recycling ratio (30% to 50% of the oxidizer weight) that does not present at any time conditions favorable to forming thermal nitrogen oxides. This constraint can be summarized by ensuring that temperature never locally exceeds about 1900 K. The maximum temperature of the cycle at any point in the combustion chamber is the sum of the local temperature at the beginning of combustion Tcomb (compression temperature) plus the temperature rise due to combustion (Tcomb).

This maximum local temperature depends firstly on parameters internal to engines such as compression ratio that governs Tcomb, on local concentrations of fuel, and on the advance towards ignition that govern temperatures Tcomb. This temperature also depends on admission conditions such as the chemical composition of the oxidizer mixture that governs the oxygen concentration, the admission temperature Tad that governs Tcomb, and the admission pressure Pad that governs the mass of oxidizer gas to be heated.

The special feature of these cycles is an admission pressure that is high for introducing burnt gas into the cylinder in addition to the fresh air required for combustion, and an exhaust temperature that is low, resulting from the reduction in the combustion temperature.

The turbocharger system must thus deliver more work with less energy.

Such cycles are particularly efficient when approaching stoichiometric combustion. The power delivered by a quantity of air admitted is proportional to the oxygen fraction that is burnt, and the dilution power of the recycled gas increases as the residual oxygen concentration decreases. However, if direct injection is used, these cycles generate carbon monoxide, unburned hydrocarbons, and particles.

The reciprocating internal combustion engine of the invention avoids those drawbacks.

The reciprocating engine of the invention presents the advantage of combining in a single pressurized module the functions of turbocharging, refrigeration, and physical and chemical post-treatment of the gas exhausted into the atmosphere, thereby enabling its overall cost to be reduced.

The reciprocating engine of the invention also makes it possible to diminish exhaust noise at source, making it possible to simplify or even eliminate the silencer or muffle downstream from the turbines of the turbocharger unit.

1. A reciprocating internal combustion engine comprising firstly at least one cylinder provided with at least one admission valve and at least one exhaust valve through which a pulsating stream of burnt gas is exhausted having a driving pressure equal to the pressure Pd that exists in the cylinder when said at least one exhaust valve is opened, and secondly a turbocharger unit actuated by said burnt gas and serving to feed said at least one cylinder with cooled compressed air, the engine being characterized in that at least a fraction of the pulsating burnt gas stream is taken from said at least one cylinder via an exhaust duct having an expansion nozzle delivering tangentially to the peripheral wall of a circularly symmetrical centrifuge chamber and perpendicularly to the axis of said chamber, and in that centrifuge chamber communicates with a feed duct for feeding the turbines of the turbocharger unit via an annular radial diffuser coaxial about the axis of said chamber and having an inlet diameter D, the static pressure in the centrifuge chamber being maintained at a pressure Ps less than the pressure Pd so as to accelerate a fraction of the burnt gas feeding a burnt gas ring into rapid rotary movement about the axis of the centrifuge chamber and that is exhausted towards the turbines, by becoming compressed and slowing down in the radial diffuser.

2. A reciprocating engine according to claim 1, characterized in that the centrifuge chamber has an axial orifice of diameter d smaller than the inlet diameter D of the radial diffuser communicating with a recycling duct for recycling the burnt gas, and in that the volume of a space lying between a notional cylinder of diameter D and a coaxial cylinder of diameter d both of length equal to the distance between the axial orifice and the inlet of the radial diffuser is preferably greater than two unit cylinder capacities of the engine.

3. A reciprocating engine according to claim 1, characterized in that the centrifuge chamber presents a volume greater than at least three times the unit cylinder capacity of the engine in order to stabilize static pressure therein when the axial orifice is closed.

4. A reciprocating engine according to claim 1, characterized in that the centrifuge chamber communicates via the axial orifice with a volume that is not less than three times the unit cylinder capacity of the engine in order to stabilize the static pressure therein.

5. A reciprocating engine according to claim 2, in which the recycling duct for recycling burnt gas takes a fraction of the burnt gas stream and transfers it with substantially no head loss to an admission manifold, the remaining fraction of the pulsating burnt gas stream feeding the turbines of the turbocharger unit, the engine being characterized in that the centrifuge chamber communicates with the recycling duct via the axial orifice, the static pressure at said orifice being substantially equal to the admission pressure of the engine.

6. A reciprocating engine according to claim 2, characterized in that the axial orifice feeds an annular radial diffuser having an inlet diameter d, the static pressure at said axial orifice being less than the admission pressure of the engine.

7. A reciprocating engine according to claim 1, characterized in that said at least one nozzle leads into said centrifuge chamber in a substantially conical segment extending between a zone of greatest diameter of said chamber and said axial orifice of diameter d.

8. A reciprocating engine according to claim 1, of the type in which said at least one cylinder is fitted with a second exhaust valve, the engine being characterized in that the second exhaust valve is connected via an exhaust duct to the recycling duct downstream from the corresponding axial orifice, the exhaust valve of the second duct opening after the exhaust valve of the first duct has opened, once the pressure in the corresponding cylinder has dropped sufficiently.

9. A reciprocating engine according to claim 1, characterized in that it includes, between the annular radial diffuser of the duct for feeding the turbines of the turbocharger unit and said turbines, an axial flow particle filter, that is preferably cylindrical and associated with means for eliminating particles deposited on the particle filter.

10. A reciprocating engine according to claim 9, characterized in that the means for eliminating particles comprise a collector pressed against the inlet face of the particle filter and movable over said face to sweep the entire surface area of said face periodically, said collector communicating with a zone in which the static pressure is less than the pressure downstream from the particle filter so as set up a counter-current flow of gas through the sector of said filter that is covered by the collector.

11. A reciprocating engine according to claim 10, characterized in that the collector communicates with the recycling duct to burn the particles extracted from said particle filter in said at least one cylinder.

12. A reciprocating engine according to claim 10, characterized in that the collector communicates with an axial zone of the centrifuge chamber in the vicinity of the radial diffuser of the turbine feed duct via a particle combustion zone situated in said chamber.

13. A reciprocating engine according to claim 10, characterized in that the particle filter is in the form of a circular cylinder having two plane end faces, said collector being driven to rotate about the axis of the filter.

14. A method of eliminating particles from burnt gas exhausted to the atmosphere by a reciprocating internal combustion engine according to any preceding claim, the method being characterized by the following steps:
passing the exhausted burnt gas through an axial flow particle filter; and
periodically putting each sector of the inlet face of the particle filter into communication with a zone where the static pressure is lower than the pressure downstream from the particle filter so as to establish a counter-current flow of gas through each sector of said particle filter, thereby entraining the particles taken from said filter towards a zone where said particles are burnt.

15. A method according to claim 14, characterized in that the zone where the static pressure is lower than the pressure downstream from the particle filter is formed by a burnt gas recycling circuit provided with a valve for adjusting the recycled gas flow rate, the particles taken being burnt in said at least one cylinder of the engine.

16. A method according to claim 14, characterized in that the zone where the static pressure is less than the pressure downstream from the particle filter is formed by an axial zone of the centrifuge chamber.

17. A method according to claim 16, characterized in that the axial zone communicates with the recycling circuit, the particles taken being burnt in said at least one cylinder of the engine.

18. A method according to claim 16, characterized in that the axial zone communicates with the turbocharger unit, the particles taken being burnt in the centrifuge chamber.
